(19) United States
(12) Patent Application Publication
(10) Pub. No.: US 2004/0134850 A1
(43) Pub. Date: Jul. 15, 2004

(54) Filters

(76) Inventor: Ian Stuart Boxall, Portsmouth (GB)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 10/691,345

(22) Filed: Oct. 21, 2003

(30) Foreign Application Priority Data
Oct. 24, 2002 (GB) 0224832.6

(51) Int. Cl. B01D 29/13

(52) U.S. Cl. 210/490; 210/500.25; 210/506; 427/244

(57) ABSTRACT

The present invention relates to metallic filter units 1, in particular, although not exclusively, for use in industrial environments, with improved resistance to degradation. The metallic filtration material 2 is coated with a protective material to reduce degradation thereof during use.

The present invention relates to filters, in particular, although not exclusively, to filters for use in industrial environments.

### BACKGROUND OF THE INVENTION

Filtration techniques are used in many industrial applications to either remove or recover substances from a material. Many applications of filters involve exposure of the filter medium to high temperature, high pressure or corrosive environments. In such environments, degradation of the filter is common.

Metallic filtration materials are widely used within industry for removal or recovery of particulates from gas and liquid flows. Such filters comprise filtration material comprising metallic fibres, wires, woven meshes and/or sintered metal powders, and supporting structures/hardware therefor. Metal filtration material is particularly suitable for high temperature, high pressure and/or corrosive environments, such as polymer melt filtration or flue gas filtration. In such environments, use of non-metallic filtration material is restricted due to thermal degradation or mechanical instability.

In an attempt to improve the lifetime of filters in industrial environments, particularly in degrading environments, filtration materials have been modified to impart greater resistance to degradation.

For example, U.S. Pat. No. 5,803,991 discloses a porous metallic filtration material which is buried in powder containing Al, Cr and NH₄Cl and then subjected to a series of heating cycles in order to alloy the Cr and Al to the metallic material and thereby improve the corrosion resistance thereof. Although such a method can increase the lifetime of a metallic filtration material, when exposed to a degrading atmosphere degradation of the filtration material resulting in problems such as reduced filtration efficiency, can still occur. Furthermore, the effectiveness of such a method can be dependent upon the particular operating environment, with some modified materials performing better in one particular environment than another environment.

### SUMMARY OF THE INVENTION

It is an object of preferred embodiments of the present invention to provide an improved filter and method of manufacture thereof.

A first aspect of the present invention provides a metallic filtration material comprising, a metallic filtration media, which metallic filtration media comprises a protective coating.

Suitably, the protective coating reduces the rate and/or degree of degradation of the metallic filtration material when in use. Suitably, the protective coating does not significantly affect the filtration properties of the filtration media. Suitably, the protective coating does not significantly affect the permeability of the filtration media.

Any suitable coating may be used. For example, the coating may comprise Silicon, a metallic material such as Au or Ag, or a ceramic material, such as, Si₂O₃, Al₂O₂, SiC or Mullite, or a mixture thereof.

Suitably, the protective coating has been applied to the filter media. Any suitable method of applying the coating to the metallic filtration media may be used. Advantageously, the coating is applied by chemical vapour deposition (CVD) or Physical Vapour Deposition (PVD).

Suitably, the protective coating is of substantially uniform depth across the surface area of the metallic filtration media.

The thickness of the coating is suitably controlled such that the presence of the coating does not significantly affect the filtration properties of the filtration media. The thickness of the coating is suitably controlled such that the presence of the coating does not significantly affect the permeability of the filtration media.

The thickness of the coating may be less than 0.05, suitably less than 0.01, preferably less than 0.0075 and more preferably less than 0.005 of the average pore size of the filtration media. The thickness of the coating may be at least 0.00025, suitably, at least 0.0005, and preferably at least 0.001 of the average pore size of the filtration media.

Suitably, the coating is at least 50 Angstrom, preferably at least 100 Angstrom and more preferably at least 200 Angstrom thick. The coating may be less than 10,000 Angstrom, suitably less than 5,000 Angstrom, preferably less than 1,500 Angstrom, and more preferably less than 1,000 Angstrom thick.

Suitably, the thickness of the coating is within the range of 50-10,000 Angstrom, preferably within the range of 100-1500 Angstrom and more preferably within the range of 20-1000 Angstrom thick.

Suitably, the protective coating has substantially-uniform composition throughout.

The metallic filtration media may comprise any suitable metallic filtration media. For example, the metallic filtration media may comprise metal fibres, metallic woven mesh, metal powder or any combination thereof. Metal fibres suitably have an average diameter in the range of 1-40 um.

Any suitable metal or metal alloy may be used to provide the metallic filtration media. Examples of suitable metallic filtration media include, iron, nickel, cobalt and alloys based on one or more thereof. Examples of suitable alloys include, stainless steel, Hastelloy (trade name of Haynes International) and Fecralloy (trade name of AEA Technology).

A second aspect of the present invention provides a filter unit comprising a metallic filtration media and a supporting structure, wherein the filtration media has a protective coating applied thereto.

The supporting structure may comprise a surface, core, framework, or a plurality thereof, arranged to support the filtration media. The supporting structure may have any suitable configuration.

The supporting structure suitably comprises a mesh, preferably a wire mesh, which may be woven. The mesh is suitably arranged substantially parallel to the extent of the filtration media. The mesh may be arranged upstream and/or down stream of the filtration media relative to the direction of gas/liquid flow in use.

Alternatively, or in addition, the supporting structure may comprise a core, about which the filtration media is supported.

The filtration media may be separate from the supporting structure. Alternatively, the filtration media may be attached, either directly or indirectly, to the supporting structure. The filtration media and the supporting structure may be connected by sintering or welding, for example.

The filter unit may have any suitable conformation. For example, the filter unit may be cylindrical, pleated or planar. The filtration media may have any suitable conformation within the filter unit. For example, the filtration media may have a pleated structure, which may then be used to form a substantially cylindrical filter unit.

The supporting structure may determine the conformation of the filter unit. Alternatively, the supporting structure and the filtration media may be arranged to provide a filter unit of the required conformation.

If the filter unit has a cylindrical conformation or the like, the supporting structure may further comprise one or more end cap. The one or more end cap is suitably arranged on the end of the cylindrical body, and may have either an open or closed configuration.

Suitably, part or all of the supporting structure also has a protective coating applied thereto. Preferably, the whole of the filter unit has a protective coating applied thereto.

Suitably, the filtration media and the supporting structure are assembled into the required conformation before the protective coating is applied.

A third aspect of the present invention provides a method of manufacturing a metallic filtration material, comprising the steps of:

(a) forming a metallic filtration media, and

(b) applying a protective coating to the metallic filtration media.

Suitably, the metallic filtration media is formed from metallic fibres, metal powder, metal wires, metallic woven mesh, or any combination thereof. The metallic filtration media may be formed by any suitable method, for example, by sintering.

The protective coating is applied to the metallic filtration media by any suitable method. Suitable methods of applying the protective coating to the filtration media include, chemical vapour deposition and physical vapour deposition.

The method may further include the step of forming the metallic filtration media into a filter unit, by providing the filtration media with a supporting structure. The filtration media may be applied, either directly or indirectly, to part or all of the supporting structure. Alternatively, or in addition, part or all of the supporting structure may be applied, either directly or indirectly, to the filtration media.

The filtration media may be provided with the supporting structure after the protective coating is applied to the filtration media. Alternatively, the filtration media may be provided with the supporting structure before the protective coating is applied to the filtration media.

The method may further include the step of applying a protective coating to the supporting structure. The protective coating of the supporting structure may be applied separately from the protective coating of the filtration media. However, the filtration media and the supporting structure are preferably provided with the protective coating in the same application process.

Any feature of the any aspect of the invention may be combined with any other aspect of the invention.

The present invention advantageously provides a filtration material and/or filter unit with improved resistance to degradation when compared with a similar filter material/filtration unit subjected to similar conditions.

### BRIEF DESCRIPTION OF THE DRAWINGS

The present invention will now be described, by way of example only, with reference to the following drawings, in which:

FIG. 1 is a partial cross-sectional side view of a filter unit;

FIG. 2 is a graph showing the percentage weight loss of coated and uncoated samples; and

FIG. 3 is another graph showing percentage weight loss of coated and uncoated samples.

### DETAILED DESCRIPTION

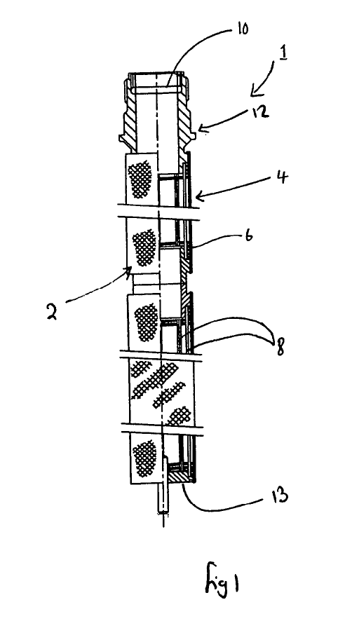

FIG. 1 shows a filter unit 1, comprising a filtration material 2 and supporting structure 8.

In this embodiment, the filtration material 2 is manufactured from random laid metal fibres, each individual fibre having a diameter in the range of 1-40 um. The fibres are then sinter-bonded together to produce the filtration material 2.

The filtration material 2 is formed into a composite structure with woven supporting meshes 6 on the upstream and downstream surfaces of the filter media. In an alternative embodiment (not shown) the supporting mesh may be on the downstream surface only or integral with the fibre structure. This arrangement can remain loose or can be joined together, for example, by sintering.

The composite structure is then formed into a cylindrical filter pack, which has a smooth surface, and the free ends are welded together to form a seam. In an alternative embodiment (not shown) the composite structure may be formed into a cylindrical filter pack with a pleated structure before the free ends are welded together to form a seam.

The filter unit 1 further comprises hardware 12, including, a core 8, located internally thereof to improve the structural stability thereof, and a closed end cap 13 welded to one end and an open end cap 10 welded to the opposite end of the filter pack to provide a flow outlet/inlet ad interface.

The complete filter element 1 is then coated with the protective coating using CVD or PVD. In this embodiment, an inert layer of fused Silica is applied as the coating. The coating is applied at a thickness between 250-1500 Angstrom. The coating covers substantially the entire surface of the filtration material 2, the supporting structure 4 and the hardware 12.

The thickness of the coating is chosen to be sufficient to impart degradation resistance whilst maintaining required permeability and filtration performance.

The bonding of the coating to the metal substrate and the structure of the coating provide a very tenacious layer which is resistant to flaking, spalling and scale formation in service, reducing the rate and/or degree of degradation of the metallic filtration material.

In separate experiments, filtration material in accordance with the present invention was subject to various operating conditions and the results are set out below.

### Experiment 1

A base metal filter media was manufactured from a nickel alloy with a basic chemical composition of 60% nickel, 23% chromium, 16% molybdenum and 1% iron. The base metal filter media was manufactured with a structure of an assymetric metal fibre composite of 12 and 22 um fibres.

Seven 85 mm diameter samples of the base metal filter media, were then coated with a 200-1000 Angstrom thick layer of fused silica by chemical vapour deposition.

Each sample was then ultrasonically cleaned in detergent rich water, rinsed with distilled water and oven dried at 100° C. The dry samples were then weighed

All of the samples were then sealed in a reaction vessel containing 300 ml of 103% sulphuric acid, and heated to a temperature of 90° C. in an oven.

At prescribed intervals, the samples were individually removed from the acid, rinsed with distilled water, ultrasonically cleaned in distilled water, oven dried at 100° C. and re-weighed.

The above process was repeated with 85 mm diameter control samples of the same base metal filter media without the fused silica coating.

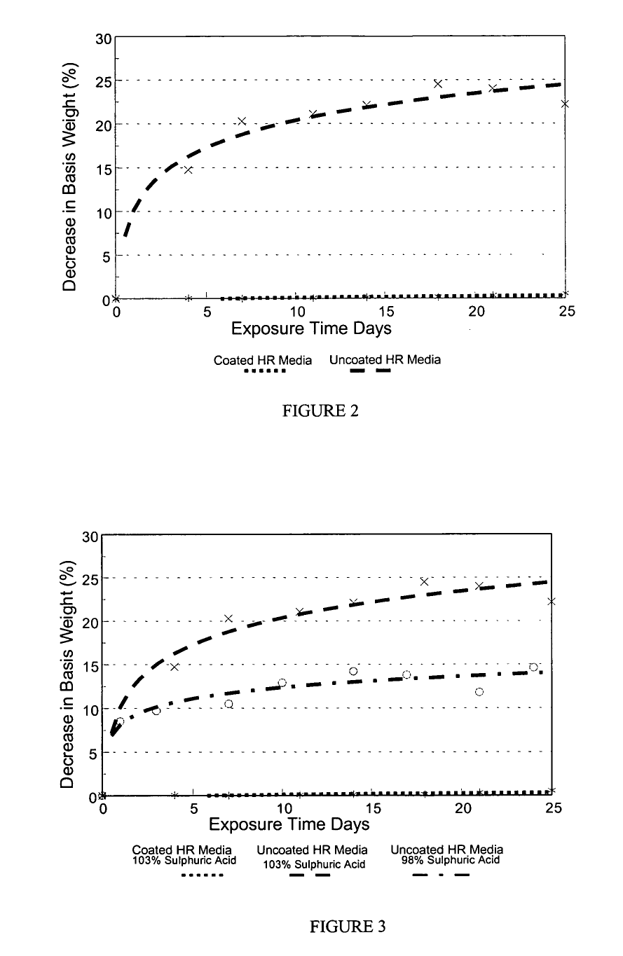

The results of experiment 1 are set out below in the graph shown in FIG. 2.

FIG. 2 shows that the percentage weight loss on the samples coated with silica was substantially zero for over 5 days exposure and less than 1% after 25 days. By way of comparison, the uncoated samples degraded relatively rapidly in the first 7 days, and more slowly thereafter. After 25 days exposure, the uncoated samples had reduced in weight by almost 25%.

This experiment illustrates that a filtration material in accordance with the present invention exhibits a significantly increased resistance to degradation in comparison with a similar uncoated filtration material.

### Experiment 2

Further control samples of the uncoated base metal filter media of experiment 1, of 60 mm diameter, were exposed to 98% sulphuric acid at 90° C. The acid concentration, temperature and exposure time were chosen to mimic the environmental conditions of the polymer manufacturing industry when producing aromatic polyamide fibres/resins.

At prescribed intervals, the samples were individually removed from the acid, cleaned using distilled water and ultrasonic agitation, oven dried at 100° C. and re-weighed.

The results of experiment were collated and superimposed on the graph of FIG. 2, to provide the graph of FIG. 3.

FIG. 3 shows that, again the uncoated samples in the 98% sulphuric acid degraded rapidly in the first 7 days, and then more slowly thereafter. After 25 days in the 98% sulphuric acid, the uncoated samples had lost almost 15% of their weight.

Again, this experiment illustrates that a filtration material in accordance with the present invention exhibits a significantly increased resistance to degradation in comparison with a similar uncoated filtration material.

What is claimed is:

1. A method of manufacturing a metallic filtration material, comprising the steps of:
(a) forming a metallic filtration media, and
(b) applying a protective coating to the metallic filtration media by either chemical vapour deposition or physical vapour deposition.

2. A method according to claim 1, wherein the metallic filtration media is formed from metal fibres, metal powder, metal wires, woven metal mesh or any combination thereof.

3. A method according to claim 1, further comprising the step of forming the metallic filtration material into a filter unit, by providing the filtration media with a supporting structure.

4. A method according to claim 3, wherein the filtration media is applied to part or all of the supporting structure.

5. A method according to claim 3, wherein part of all of the supporting structure is applied to the filtration media.

6. A method according to claim 3, wherein the filtration media is provided with the supporting structure after the protective coating is applied to the filtration media.

7. A method according to claim 3, wherein the filtration media is provided with the supporting structure before the protective coating is applied to the filtration media.

8. A method according to claim 3, further including a step of applying the protective coating to the supporting structure.

9. A method according to claim 3, wherein the filtration media and the supporting structure are provided with the protective coating in the same application process.

10. A metallic filtration material comprising, a metallic filtration media, which metallic filtration media comprises a protective coating applied to the metallic filtration material by either chemical vapour deposition or physical vapour deposition.

11. A metallic filtration material according to claim 10, wherein the protective coating comprises a ceramic, silica or metallic material.

12. A metallic filtration material according to claim 10, wherein the thickness of the coating is less than 0.05 of the average pore size of the filtration media.

13. A metallic filtration material according to claim 10, wherein the thickness of the coating is at least 0.00025 of the average pore size of the filtration media.

14. A metallic filtration material according to claim 10, wherein the coating is at least 50 Angstrom thick.

15. A metallic filtration material according to claim 10, wherein the coating is less than 2000 Angstrom thick.

16. A metallic filtration material according to claim 10, wherein the average thickness of the protective coating is in the range of 200-1000 Angstrom.

17. A metallic filtration material according to claim 10, wherein the metallic filtration material comprises metal fibres, metallic woven mesh, metal powder or any combination thereof.

18. A metallic filtration material according to claim 17, wherein the metallic filtration media comprises iron, nickel or cobalt, or an alloy of one or more thereof.

19. A filter unit comprising a metallic filtration media and a supporting structure, wherein the filtration media comprises a protective coating applied by either chemical vapour deposition or physical vapour deposition.

20. A filter unit according to claim 19, wherein the supporting structure comprises a surface, core, framework or any combination thereof, arranged to support the filtration media.

21. A filter unit according to claim 19, wherein the supporting structure comprises a wire mesh.

22. A filter unit according to claim 21, wherein the wire mesh is arranged either upstream or downstream of the filtration media in use.

23. A filter unit according to claim 19, wherein the supporting structure comprises a first wire mesh and a second wire mesh, one mesh located at the upstream side of the filtration media and the other mesh located at the downstream side of the filtration media in use.

24. A filter unit according to any one of claims 19, wherein the supporting structure comprises a core about which the filtration material is supported.

25. A filter unit according to any one of claims 19, wherein the supporting structure comprises one or more end cap.

26. A filter unit according to any one of claims 19, wherein part or all of the supporting structure has a protective coating.

27. A filter unit according to claim 19, wherein the whole of the filter unit has a protective coating applied thereto.
